(19) United States
(12) Patent Application Publication
(10) Pub. No.: US 2018/0060429 A1
(43) Pub. Date: Mar. 1, 2018

(54) AUDIO FINGERPRINT RECOGNITION APPARATUS, AUDIO FINGERPRINT RECOGNITION METHOD AND NON-TRANSITORY COMPUTER READABLE MEDIUM THEREOF

(71) Applicant: Institute For Information Industry, Taipei (TW)

(72) Inventors: Yao-Min HUANG, Taipei City (TW); Yu-Hao CHEN, Taipei City (TW); Hsin-I LAI, Taipei City (TW)

(21) Appl. No.: 15/289,949

(22) Filed: Oct. 10, 2016

(30) Foreign Application Priority Data
Aug. 25, 2016 (TW) 105127245

(51) Int. Cl. G06F 17/30; G10L 19/02; G10L 25/51; G06F 11/07; G06F 7/20

(52) U.S. Cl. CPC G06F 17/30749; G10L 19/0204; G06F 7/20; G06F 11/0709; G06F 11/076; G10L 25/51

(57) ABSTRACT

An audio fingerprint recognition apparatus, an audio fingerprint recognition method and a non-transitory computer readable medium thereof are provided. The audio fingerprint recognition apparatus stores an under-recognition audio fingerprint datum and an audio fingerprint database having a plurality of audio fingerprint data. Each audio fingerprint datum and the under-recognition audio fingerprint datum is formed of sub-fingerprint bits in a plurality of frequency bands. The audio fingerprint recognition apparatus executes the audio fingerprint recognition method including the following steps: performing a bit difference value comparison between the under-recognition audio fingerprint datum and one of the plurality of audio fingerprint data to obtain a bit error rate in each frequency band; calculating a percentage of the bit error rates in the frequency bands that are smaller than a first threshold; and labeling the compared audio fingerprint datum as a similar audio fingerprint datum when the percentage is greater than a second threshold.

### PRIORITY

This application claims priority to Taiwan Patent Application No. 105127245 filed on Aug. 25, 2016, which is hereby incorporated herein by reference in its entirety.

### FIELD

The present invention relates to an audio fingerprint recognition apparatus, an audio fingerprint recognition method, and a non-transitory computer readable medium thereof. In particular, the audio fingerprint recognition apparatus of the present invention performs a bit difference value comparison between an under-recognition audio fingerprint datum and one of a plurality of audio fingerprint data stored in an audio fingerprint database to obtain a bit error rate in each of the frequency bands, calculates a percentage of the bit error rates in the frequency bands that are smaller than a first threshold, and labels the audio fingerprint datum whose percentage is greater than a second threshold as a similar audio fingerprint datum.

### BACKGROUND

In daily lives, people often use music recognition software or applications that are currently available to search related information of an audio piece recorded by their mobile phones or other electronic products. However, other audios (e.g., audios from the surrounding environment or noises generated by the playing apparatuses themselves) other than the recorded target may be recorded simultaneously during the audio recording process, thus affecting an audio recognition result.

Music recognition software or music recognition applications that are widely used at present convert under-recognition audio into an under-recognition audio fingerprint datum so as to match it with audio fingerprint data stored in a database (e.g., as set forth in U.S. Pat. No. 7,549,052). However, if the recorded audio suffers from a lot of interference, the audio fingerprint recognition result will be affected to cause an error in the audio fingerprint recognition result, or no datum that matches the under-recognition audio fingerprint can be found in the database.

Accordingly, an urgent need exists in the art to provide an audio fingerprint recognition mechanism to reduce interferences caused by audios other than the recorded target so as to improve the recall of audio fingerprint recognition.

### SUMMARY

The disclosure includes an audio fingerprint recognition mechanism. The audio fingerprint recognition mechanism performs a bit difference value comparison between an under-recognition audio fingerprint datum and one of a plurality of audio fingerprint data stored in an audio fingerprint database to obtain a bit error rate (BER) in each of the frequency bands, and further obtains a similar audio fingerprint datum by considering only bit difference value comparison results in frequency bands that have smaller bit error rates and ignoring bit difference value comparison results in frequency bands that have greater bit error rates. Accordingly, unlike conventional audio fingerprint recognition mechanisms, the present invention can reduce the effect of interferences caused by audios other than the recorded target so as to improve the audio fingerprint recognition rate.

An audio fingerprint recognition apparatus that comprises a storage and a processor is disclosed. The storage stores an under-recognition audio fingerprint datum and an audio fingerprint database having a plurality of audio fingerprint data. Each of the audio fingerprint data and the under-recognition audio fingerprint datum is formed of a plurality of sub-fingerprint bits in a plurality of frequency bands. The processor is electrically connected to the storage and configured to execute the following steps: (a) performing a bit difference value comparison between the under-recognition audio fingerprint datum and one of the audio fingerprint data to obtain a bit error rate (BER) in each of the frequency bands; (b) calculating a percentage of the bit error rates in the frequency bands that are smaller than a first threshold; and (c) labeling the compared audio fingerprint datum as a similar audio fingerprint datum when the percentage is greater than a second threshold.

An audio fingerprint recognition method for an audio fingerprint recognition apparatus is further disclosed. The audio fingerprint recognition apparatus comprises a storage and a processor. The storage stores an under-recognition audio fingerprint datum and an audio fingerprint database having a plurality of audio fingerprint data. Each of the audio fingerprint data and the under-recognition audio fingerprint datum is formed of a plurality of sub-fingerprint bits in a plurality of frequency bands. The audio fingerprint recognition method is executed by the processor and comprises the following steps of: (a) performing a bit difference value comparison between the under-recognition audio fingerprint datum and one of the audio fingerprint data to obtain a bit error rate in each of the frequency bands; (b) calculating a percentage of the bit error rates in the frequency bands that are smaller than a first threshold; and (c) labeling the compared audio fingerprint datum as a similar audio fingerprint datum when the percentage is greater than a second threshold.

A non-transitory computer readable medium storing a computer program having a plurality of codes is further disclosed. When the computer program is loaded into an audio fingerprint recognition apparatus having a processor, the codes are executed by the processor to execute an audio fingerprint recognition method. A storage of the audio fingerprint recognition apparatus stores an under-recognition audio fingerprint datum and an audio fingerprint database having a plurality of audio fingerprint data. Each of the audio fingerprint data and the under-recognition audio fingerprint datum is formed of a plurality of sub-fingerprint bits in a plurality of frequency bands. The audio fingerprint recognition method comprises the following steps of: (a) performing a bit difference value comparison between the under-recognition audio fingerprint datum and one of the audio fingerprint data to obtain a bit error rate in each of the frequency bands; (b) calculating a percentage of the bit error rates in the frequency bands that are smaller than a first threshold; and (c) labeling the compared audio fingerprint datum as a similar audio fingerprint datum when the percentage is greater than a second threshold.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of an audio fingerprint recognition apparatus 1 according to a first embodiment of the present invention;

FIG. 2A depicts a plurality of audio fingerprint data stored in an audio fingerprint database and an under-recognition audio fingerprint datum according to the present invention;

FIG. 2B is a schematic view of a bit difference value comparison result and a masked bit different value comparison result;

FIG. 3 is a schematic view of an audio fingerprint recognition apparatus 1 according to a second embodiment of the present invention;

FIG. 4 depicts an implementation scenario between the audio fingerprint recognition apparatus 1 and a user equipment 3;

FIG. 5 is a schematic view of an audio fingerprint recognition apparatus 1 according to a third embodiment of the present invention; and

FIG. 6 is a flowchart diagram of an audio fingerprint recognition method according to a fourth embodiment of the present invention.

### DETAILED DESCRIPTION

In the following description, the present invention will be explained with reference to certain example embodiments thereof. The present invention relates to an audio fingerprint recognition apparatus, an audio fingerprint recognition method, and a non-transitory computer readable medium thereof. It shall be appreciated that these example embodiments are not intended to limit the present invention to any specific embodiments, examples, environment, applications or particular implementations described in these example embodiments. Therefore, description of these example embodiments is only for purpose of illustration rather than to limit the present invention, and the scope of this application shall be governed by the claims.

In the following embodiments and the attached drawings, elements unrelated to the present invention are omitted from depiction; and dimensional relationships among individual elements in the attached drawings are illustrated only for ease of understanding, but not to limit the actual scale.

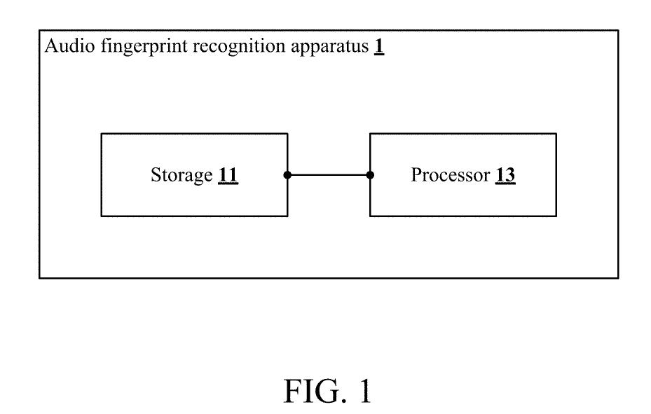

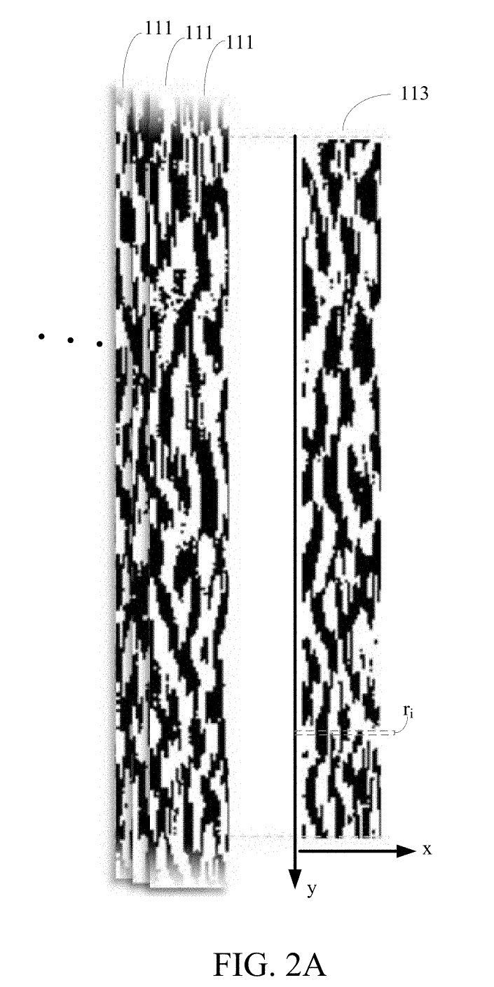

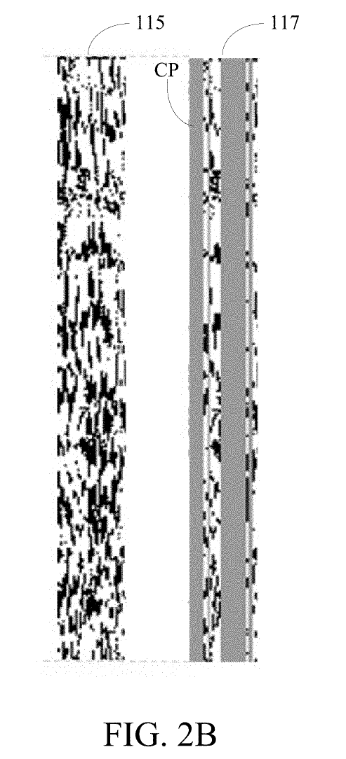

Please refer to FIG. 1, FIG. 2A and FIG. 2B for a first embodiment of the present invention. FIG. 1 is a schematic view of an audio fingerprint recognition apparatus 1 according to the present invention. The audio fingerprint recognition apparatus 1 comprises a storage 11 and a processor 13. The storage 11 stores an under-recognition audio fingerprint datum 113 and an audio fingerprint database having a plurality of audio fingerprint data 111. FIG. 2A depicts each of the audio fingerprint data 111 in the audio fingerprint database and the under-recognition fingerprint datum 113. Each of the audio fingerprint data 111 is formed of a plurality of sub-fingerprint bits in a plurality of frequency bands. Likewise, the under-recognition audio fingerprint datum 113 is also formed of a plurality of sub-fingerprint bits in a plurality of frequency bands.

Taking the under-recognition audio fingerprint datum 113 as an example, an x-axis represents the frequency bands and a y-axis represents time, so each row rᵢ in the y-axis represents the sub-fingerprint bits in the frequency bands at an i^{th} time point. In this embodiment, there are 32 frequency bands, i.e., each row rᵢ is formed of 32 sub-fingerprint bits. However, in other embodiments, there may be other numbers of frequency bands, so the number of the frequency bands is not intended to limit the scope of the present invention. Because the configuration of the audio fingerprint data can be readily appreciated by those of ordinary skill in the art, it will not be further described in detail herein.

The processor 13, which is electrically connected to the storage 11, is configured to perform a bit difference value comparison between the under-recognition audio fingerprint datum 113 and one of the audio fingerprint data 111 to obtain a bit difference value comparison result 115 (as shown in FIG. 2B), and calculate a bit error rate (BER) in each of the frequency bands in the bit difference value comparison result 115. In detail, usually each of the audio fingerprint data 111 has a time duration longer than that of the under-recognition fingerprint datum 113, so in order to determine whether the under-recognition audio fingerprint datum 113 is a part of at least one of the audio fingerprint data 111, the processor 13 performs a comparison between the under-recognition audio fingerprint datum 113 and each of the audio fingerprint data 111 one by one. The bit difference value comparison result 115 may be obtained by performing XOR operation on sub-fingerprint bits of two audio fingerprint data. In the bit difference value comparison result 115, black dots represent “1” and indicate that the sub-fingerprint bits are different from each other, and white dots represent “0” and indicate that the sub-fingerprint bits are the same.

Then after the bit difference value comparison result 115 between the under-recognition audio fingerprint datum 113 and a section of the currently compared audio fingerprint datum 111 is obtained, a percentage of the black dots in each of the frequency bands in the bit difference value comparison result 115 is further calculated by the processor 13 to obtain the bit error rates in the frequency bands. Then, the processor 13 calculates a percentage of the bit error rates in the frequency bands that are smaller than a first threshold, and labels the compared audio fingerprint datum 111 as a similar audio fingerprint datum when the percentage is greater than a second threshold.

Moreover, as audios from the surrounding environment or noises generated by the playing apparatus itself usually fall within a particular frequency band, the present invention masks comparison results of frequency bands whose bit error rates are greater than the first threshold to obtain a masked bit difference value comparison result 117. As shown in FIG. 2B, “CP” indicates a masked portion. After the bit difference value comparison results of the frequency bands that have greater bit error rates are masked, the processor 13 determines whether a percentage of the unmasked portion is greater than the second threshold (i.e., whether the number of unmasked frequency bands is sufficient) in the masked bit difference value comparison result 117 so as to determine whether the compared audio fingerprint datum 111 is the similar audio fingerprint datum. The processor 13 labels the compared audio fingerprint datum 111 as the similar audio fingerprint datum when it is determined that the percentage of the unmasked frequency bands is greater than the second threshold.

As an example, when the first threshold is 0.3 and the second threshold is 25%, the processor 13 masks the comparison results of the frequency bands that have bit error rates greater than 0.3 in the bit difference value comparison result 115, and determines through calculation whether the percentage of the unmasked portion is greater than 25% in the masked bit difference value comparison result 117 (i.e., calculates a percentage of the frequency bands having bit error rates smaller than 0.3 among all the frequency bands in the bit difference value comparison result 115 and determines whether the percentage is greater than 25%). The compared audio fingerprint datum 111 is labeled by the processor 13 as the similar audio fingerprint datum when the percentage of the unmasked portion is greater than 25%. Otherwise, the processor 13 continues to perform the bit difference value comparison between the under-recognition audio fingerprint datum 113 and other sections of the currently compared audio fingerprint datum 111 and perform the aforesaid masking and percentage determining operations when the percentage of the unmasked portion is smaller than 25%. If no section of the currently compared audio fingerprint datum is similar to the under-recognition audio fingerprint datum 113, then the processor 13 selects a next audio fingerprint datum 111 from the audio fingerprint database and performs the aforesaid bit difference value comparison, masking and percentage determining operations.

It shall be appreciated that, the aforesaid values of the first threshold and second threshold are adapted for general use. However, in practical applications, the first threshold and the second threshold may be adjusted depending on requirements for the recall and the precision or depending on noise interference conditions. How the first threshold and the second threshold are adjusted based on evaluation and alignment of noises from the surrounding environment can be readily appreciated by those of ordinary skill in the art from the aforesaid description, and thus will not be further described herein.

As described above, in the bit difference value comparison result, a greater bit error rate means that the under-recognition audio fingerprint datum and the compared audio fingerprint datum have a larger difference therebetween in the frequency band, which difference is usually caused by the interferences (i.e., audios other than the recorded target). Therefore, in order to improve the audio fingerprint recognition rate, the audio fingerprint recognition apparatus of the present invention determines whether the under-recognition audio fingerprint datum is similar to the currently compared audio fingerprint datum by masking the bit difference value comparison results where the bit error rates are greater than the first threshold and retaining the bit difference value comparison results of the frequency bands that have preferred bit error rates.

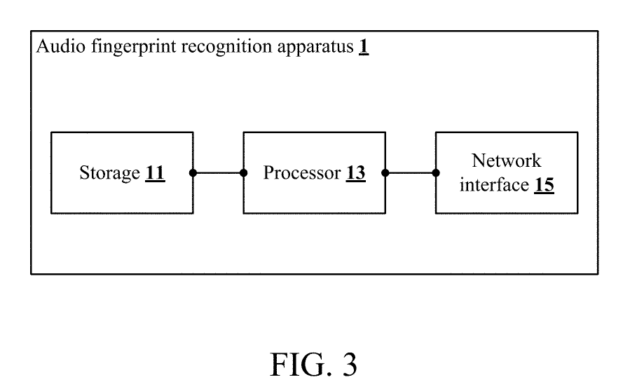

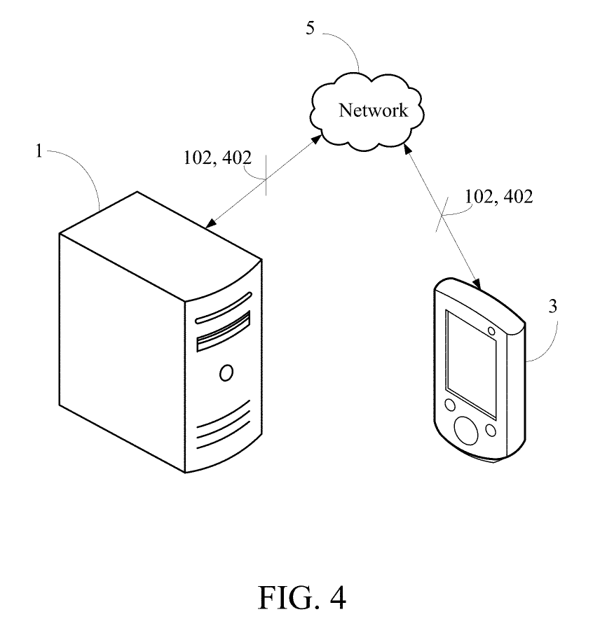

Please refer to FIG. 3 and FIG. 4 for a second embodiment of the present invention, which is an extension of the first embodiment. As shown in FIG. 3, an audio fingerprint recognition apparatus 1 of this embodiment further comprises a network interface 15, and in this embodiment, the audio fingerprint recognition apparatus 1 is a server. The processor 13 receives an audio recording datum from a user equipment (UE) via the network interface 15 and converts the audio recording datum into an under-recognition audio fingerprint datum. The processor 13 further generates an output message 102 according to a similar audio fingerprint datum and transmits the output message 102 to the user equipment via the network interface 15.

FIG. 4 depicts an implementation scenario between the audio fingerprint recognition apparatus 1 and the user equipment 3. The user equipment 3 may be a smart phone, which can record an audio of a target (e.g., an audio from a radio broadcast, an audio from television playing). The audio fingerprint recognition apparatus 1 may be a music server, a television program server, or any multimedia server that has an audio fingerprint database. After the audio of the object is recorded, the user equipment 3 generates an audio recording datum 402 and transmits the audio recording datum 402 to the audio fingerprint recognition apparatus 1 via a network 5. The network 5 may be, but is not limited to, a combination of various networks such as a local area network (LAN), a telecommunication network, the Internet and the like.

After receiving the audio recording datum 402, the audio fingerprint recognition apparatus 1 converts the audio recording datum 402 into the under-recognition audio fingerprint datum 113, and performs a comparison between the under-recognition audio fingerprint datum 113 and the audio fingerprint data 111 in its audio fingerprint database. Once a similar audio fingerprint datum is found, the audio fingerprint recognition apparatus 1 generates the output message 102 according to the similar audio fingerprint datum and transmits the output message 102 to the user equipment 3 via the network 5. The output message 102 can include music information, program information or the like (but not limited thereto) corresponding to the similar audio fingerprint datum. As a result, the user equipment 3 can obtain related information on the audio of the object recorded from the audio fingerprint recognition apparatus 1 and display the related information on a screen of the user equipment 3.

It shall be appreciated that, once one similar audio fingerprint datum has been found by the audio fingerprint recognition apparatus 1 in the comparison process, the subsequent comparison procedure is stopped and the output message 102 is generated directly according to the similar audio fingerprint datum and transmitted to the user equipment 3. However, in other embodiments, the processor 13 may also perform a comparison between the under-recognition audio fingerprint datum 113 and each of the audio fingerprint data 111 in the audio fingerprint database during the process of recognizing the audio fingerprint data so as to obtain one or more audio fingerprint data and label the audio fingerprint data as the similar audio fingerprint data. In this case, the processor 13 selects one of the similar audio fingerprint data whose percentage of the bit rate error rates smaller than the first threshold is the greatest as a confirmed audio fingerprint datum before the output message 102 is generated, and generates the output message 102 according to the confirmed audio fingerprint datum and transmits the output message 102 to the user equipment via the network interface 15. Moreover, in other embodiments, the output message 102 may also be generated according to multiple similar audio fingerprint data so as to include multimedia information corresponding to the multiple similar audio fingerprint data.

As an example, when a user wants to learn information of a broadcasting program (e.g., “Afternoon Life”) that he/she is listening to, he/she can record an audio of the broadcasting program within a certain time via a microphone of the user equipment 3 to generate an audio recording datum 402. The recorded audio usually contains the audio of the broadcasting program and noises from the surrounding environment. Subsequently, after receiving the audio recording datum 402 from the user equipment 3, the audio fingerprint recognition apparatus 1 converts the audio recording datum 402 into an under-recognition audio fingerprint datum 113 and performs a bit difference value comparison between the under-recognition fingerprint datum 113 and each of the audio fingerprint data 111 in the audio fingerprint database. After a similar audio fingerprint datum is obtained, the audio fingerprint recognition apparatus 1 determines the multimedia information corresponding to the similar audio fingerprint datum as the broadcasting program “Afternoon Life” and transmits related information of the broadcasting program “Afternoon Life” to the user equipment 3 via the output message 102.

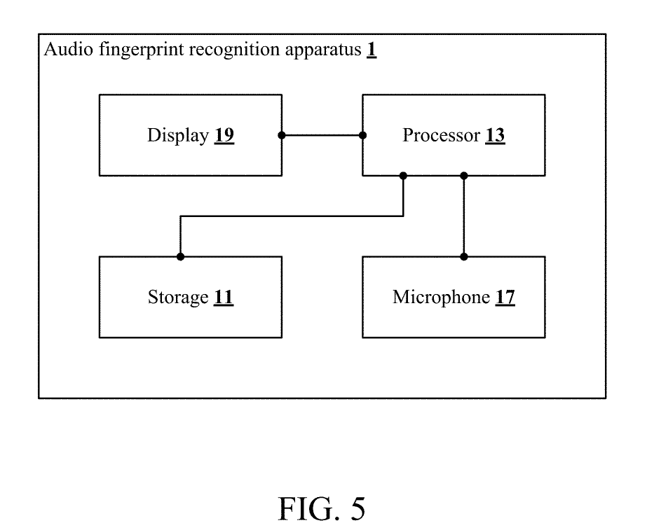

Please refer to FIG. 5 for a third embodiment of the present invention, which is an extension of the first embodiment. The audio fingerprint recognition apparatus 1 in this embodiment is a user equipment, e.g., a smart phone, a tablet computer or the like. As illustrated in FIG. 5, the audio fingerprint recognition apparatus 1 further comprises a microphone 17 and a display 19 which are both electrically connected to the processor 13. The microphone 17 senses an audio of a recorded target to generate an audio signal and transmit the audio signal to the processor 13. After receiving the audio signal from the microphone 17, the processor 13 generates an audio recording datum according to the audio signal and converts the audio recording datum into an under-recognition audio fingerprint datum 113. Subsequently, the processor 13 performs a comparison between the under-recognition audio fingerprint datum 113 and audio fingerprint data 111 in its audio fingerprint database. Once a similar audio fingerprint datum has been found, the processor 13 generates an output message according to the similar audio fingerprint datum and displays the output message via the display 19.

Similarly, once one similar audio fingerprint datum has been found by the processor 13 in the comparison process, the subsequent comparison procedure is stopped and the output message is generated directly according to the similar audio fingerprint datum. However, in other embodiments, the processor 13 may also perform a comparison between the under-recognition audio fingerprint datum 113 and each of the audio fingerprint data 111 in the audio fingerprint database during the process of recognizing the audio fingerprint data to obtain one or more audio fingerprint data and label the audio fingerprint data as the similar audio fingerprint data. In this case, when at least one similar audio fingerprint datum is obtained, the processor 13 selects one of the similar audio fingerprint data whose percentage of the bit rate error rates smaller than the first threshold is the greatest as a confirmed audio fingerprint datum before the output message is generated, and generates the output message according to the confirmed audio fingerprint datum. Moreover, in other embodiments, the output message may also be generated according to multiple similar audio fingerprint data so as to include multimedia information corresponding to the multiple similar audio fingerprint data.

As an example, when watching a singer singing a song (e.g., “Rose”) in a television program, the user may be aware that the song has been stored in his/her smart phone (i.e., the audio fingerprint recognition apparatus 1) but have trouble in recalling its name at the moment. Therefore, the user can use the microphone 17 to sense the audio played on the television within a certain time and make the smart phone covert the audio recording datum which is recorded by the smart phone into the under-recognition audio fingerprint datum 113. Then, a bit difference value comparison is performed between the under-recognition audio fingerprint datum 113 and each of the audio fingerprint data 111 in the audio fingerprint database stored in the smart phone to obtain a similar audio fingerprint datum. If the smart phone determines that the similar audio fingerprint datum corresponds to the song “Rose” stored therein, then the output message is generated and displayed via the display 19. In this manner, the user can find the corresponding song in his/her smart phone immediately.

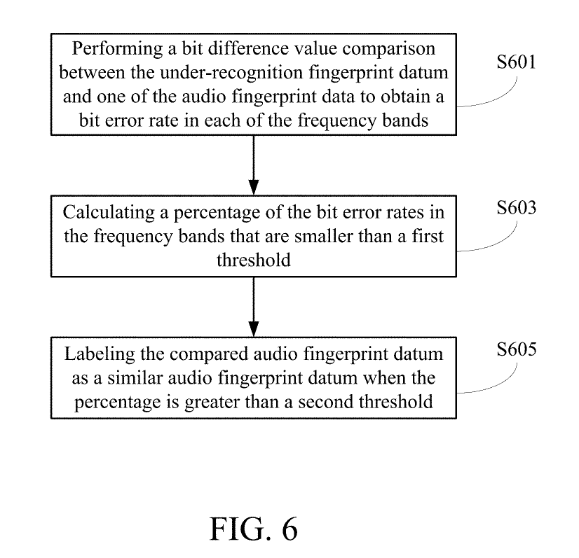

A fourth embodiment of the present invention is an audio fingerprint recognition method, a flowchart diagram of which is shown in FIG. 6. The audio fingerprint recognition method is adapted for use in an audio fingerprint recognition apparatus (e.g., the audio fingerprint recognition apparatus 1 of each of the aforesaid embodiments). The audio fingerprint recognition apparatus comprises a storage and a processor. The storage stores an under-recognition fingerprint datum and an audio fingerprint database having a plurality of audio fingerprint data. Each of the audio fingerprint data and the under-recognition audio fingerprint datum is formed of a plurality of sub-fingerprint bits in a plurality of frequency bands. The audio fingerprint recognition method is executed by the processor.

Firstly in step S601, a bit difference value comparison is performed between the under-recognition audio fingerprint datum and one of the audio fingerprint data to obtain a bit error rate in each of the frequency bands. Then in step S603, a percentage of the bit error rates in the frequency bands that are smaller than a first threshold is calculated. Finally in step S605, the compared audio fingerprint datum is labeled as a similar audio fingerprint datum when the percentage is greater than a second threshold.

Moreover, in other embodiments, when the audio fingerprint recognition apparatus is a server and further comprises a network interface, the audio fingerprint recognition method of the present invention may further comprise the steps of: receiving an audio recording datum from a user equipment via the network interface; converting the audio recording datum into an under-recognition audio fingerprint datum; generating an output message according to a similar audio fingerprint datum; and transmitting the output message to the user equipment via the network interface.

Additionally, in other embodiments, when the audio fingerprint recognition apparatus is a user equipment and further comprises a microphone and a display, the audio fingerprint recognition method of the present invention further comprises the following steps of: receiving an audio signal from the microphone; generating an audio recording datum according to the audio signal; converting the audio recording datum into an under-recognition audio fingerprint datum; generating an output message according to a similar audio fingerprint datum; and displaying the output message via a display.

Moreover, in other embodiments, the audio fingerprint recognition method of the present invention may further comprise the steps of: executing step S601 to S603 to perform a bit difference value comparison between the under-recognition audio fingerprint datum and each of the audio fingerprint data; and when at least one the similar audio fingerprint datum is obtained, selecting one of the at least one similar audio fingerprint datum whose percentage is the greatest as a confirmed audio fingerprint datum.

Besides, when the audio fingerprint recognition apparatus is a server and further comprises a network interface, the audio fingerprint recognition method may further comprise the steps of: receiving an audio recording datum from a user apparatus via the network interface; converting the audio recording datum into an under-recognition audio fingerprint datum; generating an output message according to a confirmed audio fingerprint datum; and transmitting the output message to the user equipment via the network interface. On the other hand, when the audio fingerprint recognition apparatus is a user equipment and further comprises a microphone and a display, the audio fingerprint recognition method may further comprise the following steps of: receiving an audio signal from the microphone; generating an audio recording datum according to the audio signal; converting the audio recording datum into an under-recognition audio fingerprint datum; generating an output message according to a confirmed audio fingerprint datum; and displaying the output message via the display.

In addition to the aforesaid steps, the audio fingerprint recognition method of the present invention may also execute all the operations described in all the aforesaid embodiments and have all the corresponding functions. How this embodiment executes these operations and have these functions will be readily appreciated by those of ordinary skill in the art based on the explanation of the aforesaid embodiments, and thus will not be further described herein.

Moreover, the aforesaid audio fingerprint recognition method of the present invention may be implemented by a non-transitory computer readable medium. The non-transitory computer readable medium stores a computer program having a plurality of codes. After the computer program is loaded into and installed in an electronic apparatus (e.g., the audio fingerprint recognition apparatus 1) having a processor, the codes are executed by the processor to execute the audio fingerprint recognition method of the present invention. The non-transitory computer readable medium may be, for example, a read only memory (ROM), a flash memory, a floppy disk, a hard disk, a compact disk (CD), a mobile disk, a magnetic tape, a database accessible to networks, or any other storage with the same function and well known to those skilled in the art.

In summary, the audio fingerprint recognition method of the present invention performs a bit difference value comparison between an under-recognition audio fingerprint datum and a plurality of audio fingerprint data stored in an audio fingerprint database, and obtains a similar audio fingerprint datum from only bit difference value comparison results in frequency bands that have smaller bit error rates by masking bit difference value comparison results in frequency bands that have greater bit error rates, thus improving the recall of audio fingerprint recognition.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An audio fingerprint recognition apparatus, comprising:
a storage, being configured to store an under-recognition audio fingerprint datum and an audio fingerprint database having a plurality of audio fingerprint data, each of the audio fingerprint data and the under-recognition audio fingerprint datum being formed of a plurality of sub-fingerprint bits in a plurality of frequency bands; and
a processor electrically connected to the storage, being configured to execute the following steps:
(a) performing a bit difference value comparison between the under-recognition audio fingerprint datum and one of the audio fingerprint data to obtain a bit error rate (BER) in each of the frequency bands;
(b) calculating a percentage of the bit error rates in the frequency bands that are smaller than a first threshold; and
(c) labeling the compared audio fingerprint datum as a similar audio fingerprint datum when the percentage is greater than a second threshold.

2. The audio fingerprint recognition apparatus of claim 1, wherein the first threshold is 0.3, and the second threshold is 25%.

3. The audio fingerprint recognition apparatus of claim 1, wherein the audio fingerprint recognition apparatus is a server and further comprises a network interface electrically connected to the processor, the processor further receives an audio recording datum from a user equipment (UE) via the network interface and converts the audio recording datum into the under-recognition audio fingerprint datum, and the processor further generates an output message according to the similar audio fingerprint datum and transmits the output message to the user equipment via the network interface.

4. The audio fingerprint recognition apparatus of claim 1, wherein the audio fingerprint recognition apparatus is a user equipment and further comprises a microphone and a display that are electrically connected to the processor, the processor receives an audio signal from the microphone so as to generate an audio recording datum according to the audio signal and converts the audio recording datum into the under-recognition audio fingerprint datum, and the processor further generates an output message according to the similar audio fingerprint datum and displays the output message via the display.

5. The audio fingerprint recognition apparatus of claim 1, wherein the processor further executes the steps (a) to (c) repeatedly to perform the bit difference value comparison between the under-recognition audio fingerprint datum and each of the audio fingerprint data and, when at least one the similar audio fingerprint datum is obtained, the processor further selects one of the at least one the similar audio fingerprint datum whose percentage is the greatest as a confirmed audio fingerprint datum.

6. The audio fingerprint recognition apparatus of claim 5, wherein the audio fingerprint recognition apparatus is a server and further comprises a network interface electrically connected to the processor, the processor further receives an audio recording datum from a user equipment via the network interface and converts the audio recording datum into the under-recognition audio fingerprint datum, and the processor further generates an output message according to the confirmed audio fingerprint datum and transmits the output message to the user equipment via the network interface.

7. The audio fingerprint recognition apparatus of claim 5, wherein the audio fingerprint recognition apparatus is a user equipment and further comprises a microphone and a display that are electrically connected to the processor, the processor receives an audio signal from the microphone to generate an audio recording datum according to the audio signal and converts the audio recording datum into the under-recognition audio fingerprint datum, and the processor further generates an output message according to the confirmed audio fingerprint datum and displays the output message via the display.

8. An audio fingerprint recognition method for an audio fingerprint recognition apparatus, the audio fingerprint recognition apparatus comprising a storage and a processor, the storage storing an under-recognition audio fingerprint datum and an audio fingerprint database having a plurality of audio fingerprint data, each of the audio fingerprint data and the under-recognition audio fingerprint datum being formed of a plurality of sub-fingerprint bits in a plurality of frequency bands, and the audio fingerprint recognition method being executed by the processor and comprising the following steps of:
(a) performing a bit difference value comparison between the under-recognition audio fingerprint datum and one of the audio fingerprint data to obtain a bit error rate (BER) in each of the frequency bands;
(b) calculating a percentage of the bit error rates in the frequency bands that are smaller than a first threshold; and
(c) labeling the compared audio fingerprint datum as a similar audio fingerprint datum when the percentage is greater than a second threshold.

9. The audio fingerprint recognition method of claim 8, wherein the first threshold is 0.3, and the second threshold is 25%.

10. The audio fingerprint recognition method of claim 8, wherein the audio fingerprint recognition apparatus is a server and further comprises a network interface, and the audio fingerprint recognition method further comprises the following steps of:
receiving an audio recording datum from a user equipment (UE) via the network interface;
converting the audio recording datum into the under-recognition audio fingerprint datum;
generating an output message according to the similar audio fingerprint datum; and
transmitting the output message to the user equipment via the network interface.

11. The audio fingerprint recognition method of claim 8, wherein the audio fingerprint recognition apparatus is a user equipment and further comprises a microphone and a display, and the audio fingerprint recognition method further comprises the following steps of:
receiving an audio signal from the microphone;
generating an audio recording datum according to the audio signal;
converting the audio recording datum into the under-recognition audio fingerprint datum;
generating an output message according to the similar audio fingerprint datum; and
displaying the output message via the display.

12. The audio fingerprint recognition method of claim 8, further comprising the following steps of:
executing the steps (a) to (c) repeatedly to perform the bit difference value comparison between the under-recognition audio fingerprint datum and each of the audio fingerprint data; and
when at least one the similar audio fingerprint datum is obtained, selecting one of the at least one the similar audio fingerprint datum whose percentage is the greatest as a confirmed audio fingerprint datum.

13. The audio fingerprint recognition method of claim 12, wherein the audio fingerprint recognition apparatus is a server and further comprises a network interface, and the audio fingerprint recognition method further comprises the following steps of:
receiving an audio recording datum from a user equipment via the network interface;
converting the audio recording datum into the under-recognition audio fingerprint datum;
generating an output message according to the confirmed audio fingerprint datum; and
transmitting the output message to the user equipment via the network interface.

14. The audio fingerprint recognition method of claim 12, wherein the audio fingerprint recognition apparatus is a user equipment and further comprises a microphone and a display, and the audio fingerprint recognition method further comprises the following steps of:
receiving an audio signal from the microphone;
generating an audio recording datum according to the audio signal;
converting the audio recording datum into the under-recognition audio fingerprint datum;
generating an output message according to the confirmed audio fingerprint datum; and
displaying the output message via the display.

15. A non-transitory computer readable medium storing a computer program having a plurality of codes, wherein when the computer program is loaded into an audio fingerprint recognition apparatus having a processor, the codes are executed by the processor to execute an audio fingerprint recognition method, a storage of the audio fingerprint recognition apparatus stores an under-recognition audio fingerprint datum and an audio fingerprint database having a plurality of audio fingerprint data, each of the audio fingerprint data and the under-recognition audio fingerprint datum is formed of a plurality of sub-fingerprint bits in a plurality of frequency bands, and the audio fingerprint recognition method comprises:
(a) performing a bit difference value comparison between the under-recognition audio fingerprint datum and one of the audio fingerprint data to obtain a bit error rate (BER) in each of the frequency bands;
(b) calculating a percentage of the bit error rates in the frequency bands that are smaller than a first threshold; and
(c) labeling the compared audio fingerprint datum as a similar audio fingerprint datum when the percentage is greater than a second threshold.

16. The non-transitory computer readable medium of claim 15, wherein the first threshold is 0.3, and the second threshold is 25%.

17. The non-transitory computer readable medium of claim 15, wherein the audio fingerprint recognition apparatus is a server and further comprises a network interface, and the audio fingerprint recognition method further comprises:
receiving an audio recording datum from a user equipment (UE) via the network interface;
converting the audio recording datum into the under-recognition audio fingerprint datum;
generating an output message according to the similar audio fingerprint datum; and
transmitting the output message to the user equipment via the network interface.

18. The non-transitory computer readable medium of claim 15, wherein the audio fingerprint recognition apparatus is a user equipment and further comprises a microphone and a display, and the audio fingerprint recognition method further comprises:
receiving an audio signal from the microphone;
generating an audio recording datum according to the audio signal;
converting the audio recording datum into the under-recognition audio fingerprint datum;
generating an output message according to the similar audio fingerprint datum; and
displaying the output message via the display.

19. The non-transitory computer readable medium of claim 15, wherein the audio fingerprint recognition method further comprises:
executing the steps (a) to (c) repeatedly to perform the bit difference value comparison between the under-recognition audio fingerprint datum and each of the audio fingerprint data; and
when at least one the similar audio fingerprint datum is obtained, selecting one of the at least one the similar audio fingerprint datum whose percentage is the greatest as a confirmed audio fingerprint datum.

20. The non-transitory computer readable medium of claim 19, wherein the audio fingerprint recognition apparatus is a server and further comprises a network interface, and the audio fingerprint recognition method further comprises:
receiving an audio recording datum from a user equipment via the network interface;
converting the audio recording datum into the under-recognition audio fingerprint datum;
generating an output message according to the confirmed audio fingerprint datum; and
transmitting the output message to the user equipment via the network interface.

21. The non-transitory computer readable medium of claim 19, wherein the audio fingerprint recognition apparatus is a user equipment and further comprises a microphone and a display, and the audio fingerprint recognition method further comprises:
receiving an audio signal from the microphone;
generating an audio recording datum according to the audio signal;
converting the audio recording datum into the under-recognition audio fingerprint datum;
generating an output message according to the confirmed audio fingerprint datum; and
displaying the output message via the display.
